(19) United States
(12) Patent Application Publication
(10) Pub. No.: US 2025/0113161 A1
(43) Pub. Date: Apr. 3, 2025

(54) GEOFENCE-BASED REMOTE PROCESSING SYSTEM

(71) Applicant: Aven Holdings, Inc., Burlingame, CA (US)

(72) Inventor: Usman Ghani, Burlingame, CA (US)

(21) Appl. No.: 18/902,157

(22) Filed: Sep. 30, 2024

Related U.S. Application Data
(60) Provisional application No. 63/586,275, filed on Sep. 28, 2023.

(51) Int. Cl. H04W 4/021; G06V 20/62

(52) U.S. Cl. CPC H04W 4/021; G06V 20/625

(57) ABSTRACT

A method and system for geofence-based remote online processing are provided. The method includes defining a geofence area for a geofence-based remote online processing, collecting location information of a user attending to the geofence-based remote online processing, comparing the location information of the user with the geofence area to determine whether the user has entered into the geofence area, and in response to the user having entered into the geofence area, activating a link sent to a user device of the user to allow the user to attend the remote online processing through an audiovisual platform.

### CROSS-REFERENCE TO RELATED APPLICATION

The application claims priority of U.S. provisional application No. 63/586,275 filed Sep. 28, 2023, which is hereby incorporated by reference in its entirety.

### TECHNICAL FIELD

This disclosure generally relates to computer systems and methods for remote processing, and more particularly to techniques for geofence-based settings for remote processing.

### BACKGROUND

Over the past few years, there has been a major shift to bringing different processing online. This trend is changing the way that documents are signed and exchanged. While online processing offers some benefits such as time-saving, error reduction, wider ranges of access, and the like, some people also raise safety and security concerns regarding online processing. For example, how do the online processing-related technologies ensure that the documents through the process have not been modified, and how do the related technologies verify the signer's identity? Since completely online processing does not involve any physical or onsite verification, certain documents and user IDs such as driver licenses can be forged, which is not readily verified just based on the provided video or image information in existing online processing platforms.

Accordingly, it is desirable to have an additional layer of verification process that goes beyond merely online video or image verifications in online processing, so as to increase the security and reliability of the online processing.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

To address the aforementioned shortcomings, a method and system for geofence-based remote online processing are provided. The method includes defining a geofence area for a geofence-based remote online processing, collecting location information of a user attending to the geofence-based remote online processing, comparing the location information of the user with the geofence area to determine whether the user has entered into the geofence area, and in response to the user having entered into the geofence area, activating a link sent to a user device of the user to allow the user to attend the remote online processing through an audiovisual platform.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1 is a schematic diagram illustrating an application scenario for geofence-based remote online processing, according to embodiments of the disclosure.

FIG. 2A is a block diagram illustrating an example architecture for a geofence-based remote online processing system, according to embodiments of the disclosure.

FIG. 2B is a block diagram illustrating an example architecture for a geofence-based remote eClosing system, according to embodiments of the disclosure.

FIG. 3 illustrates example components included in a geofence-based remote application, according to embodiments of the disclosure.

FIG. 4 is a flow chart of an example method for geofence-based remote online processing, according to embodiments of the disclosure.

FIG. 5 is a flow chart of an example method for geofence-based remote eClosing, according to embodiments of the disclosure.

FIG. 6 is a block diagram of an example computer for implementing systems and methods described in reference to FIGS. 1-5.

### DETAILED DESCRIPTION

The figures (FIGS.) and the following description relate to some embodiments by way of illustration only. It is to be noted that from the following description, alternative embodiments of the structures and methods disclosed herein will be readily recognized as viable alternatives that may be employed without departing from the principles of the present disclosure.

Reference will now be made in detail to several embodiments, examples of which are illustrated in the accompanying figures. It is to be noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

The present disclosure addresses the aforementioned problems and other problems in the existing online processing by providing a geofence-based settings for remote processing. Briefly, a geofence area may be defined in a specific area, which is equipped with necessary electronic devices or apparatus for setting up various remote or online processing. For example, the geofence area may be set up with certain electronic devices for providing wired or wireless communications, electronic devices for setting up audiovisual communications, electronic devices for user identity or location verification purposes, and electronic devices specifically set up for various other purposes, such as document scanning and/or transmission to remote locations, among others. The setting up of a geofence-based remote processing facility may offer many benefits and advantages, and be applied to different application scenarios.

For example, for a user seeking a loan or credit approval through eClosing, the user may be directed to a geofence-based facility for remote processing. This geofence-based remote processing may provide additional physical verification to ensure that a user seeking the loan or credit approval is at least close to an address included in the documents used for eClosing.

In the present disclosure, the geofence-based settings for remote processing specifically address the technical problems necessarily rooted in computer technology, for example, in remote and/or online processing-related technology. In the existing online processing platforms, the mobile devices used in the online processing platforms are under the control of users, which may provide opportunities to make up, modify, or even forge documents before they are submitted through network communication for processing, leading to safety concerns of these online processing platforms. For example, an online person from another state or even another country may use fake IDs and/or documents to apply for loan or credit approval under another person's name, which may be not easily detected since all the documents are electronically processed and transmitted. Even live video chat during remote online processing can be conducted, it is difficult to prevent faults since a live video chat may be conducted by a user from anywhere around the world, and a user in Europe may use fake IDs and documents to apply for loan or credit approval in the US. By setting up a geofence-based remote processing, the disclosed online processing system provides at least one layer of physical verification (e.g., address verification) among other possible security strategies as will be described in detail later, which improves the safety and reliability of certain online processing.

It is to be noted that the benefits and advantages described herein are not all-inclusive, and many additional features and advantages will be further described under the context of specific embodiments. In addition, some additional features and advantages will become apparent to one of ordinary skill in the art in view of the figures and the following descriptions.

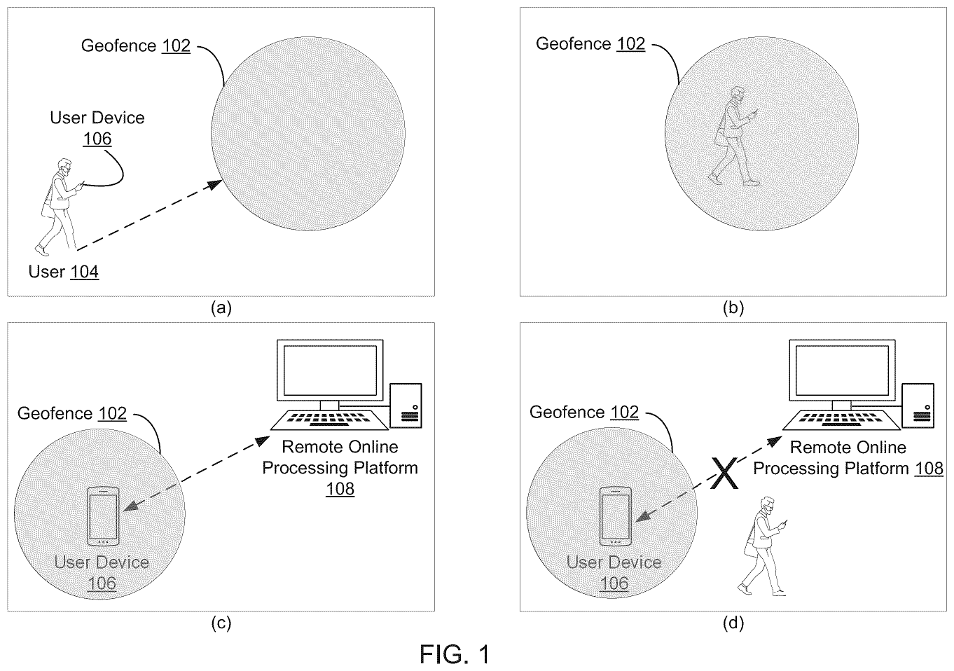

FIG. 1 illustrates an example application for geofence-based remote online processing, according to one embodiment. As illustrated, to implement a geofence-based remote online processing, a geofence 102 is first defined, as illustrated in Part (a) of FIG. 1. In the embodiments disclosed herein, a geofence (or geofence area) 102 may refer to a virtual perimeter that corresponds to a physical geographic area. Specifically, a geofence may refer to the outermost perimeter of a geofenced region, which is made up of a collection of coordinates (e.g., latitude and longitude). In real applications, the outmost perimeter of a geofence may be defined using certain mapping software, which allows drawing or selecting the geofence over a desired geographic area that corresponds to the collection of coordinates. While geofence 102 is illustrated as a circle in Part (a) of FIG. 1, in real applications, a geofence can be in any other desired shape. For example, the outmost perimeter of a geofence region may have a shape that corresponds to a contour of a building, a parking lot, a room or a number of rooms in a building, a drive-through area, etc. A user may define the geofence corresponding to the contour by selecting a building, a parking lot, a driving-through area, and the like by selecting the desired structure/area in the mapping software.

In some embodiments, once a geofence area is defined, it can be used to detect whether a user has entered the geofence area or not based on the location information of a user. For example, in Part (a) of FIG. 1, a user 104 can be determined to have entered the geofence 102 or not based on the location information of the user. Here, the location information of the user may be determined by using positioning technologies like the global positioning system (GPS) or many other different means as will be described in detail later. For example, the user 104 may carry a user device 106 (e.g., a mobile phone) that can provide GPS information. Based on the GPS information provided in real-time, it can be determined whether the user has entered the geofence 102 or not. Part (b) of FIG. 1 illustrates an example scenario in which the user has entered the geofence area.

In some embodiments, certain actions can be enabled for a user once the user has entered a predefined geofence and remains in that area. For example, wired or wireless communications may be enabled in the geofence area if the user does not have a mobile device with commutation functions. Other accessories including certain verification devices or document processing devices as will be described later, all of which may facilitate the user in the expected remote online processing in the geofence area. For example, as illustrated in Part (c) of FIG. 1, once the user 104 is detected to have entered the geofence area 104, the user (more specifically through the user device 106) may be enabled to perform certain remote online processing-related activities through the user device 106 and/or various accessories. If the user 104 has not entered the geofence area 104 or if the user has left the geofence area 104, the user (more specifically the user device 106) may be disabled to perform the remote online processing, as illustrated in Part (d) of FIG. 1. In this way, the physical location verification-based remote online processing is ensured.

In some embodiments, in the remote online notarization processes enabled for a user (or user device), the user 104 may meet with a person online, in real-time, using audiovisual technology, e.g., through a remote online processing platform 108 illustrated in Part (c) of FIG. 1. The platform may include a backend server and may also include certain functions enabled on the user device for the remote online processing. It is distinct from traditional, in-person processing, where the attendee must be physically present in the same location.

In some embodiments, multi-point, identity and document verification, including personal identification verification, may be used to ensure the integrity of the online processing in the geofence area described above. For example, for loan or credit approval, proof of identity (e.g., utility bill, lease or rental agreement, mortgage statement, proof of insurance on home or vehicle, voter registration card, property tax receipt, band or credit card statement), employer and income verification, and/or proof of address may be verified during the multi-point, identity, and document verification process. In some embodiments, for bank card applications backed by HELOC, certain property documents may be also verified through the process, which include but are not limited to a copy of the homeowner's insurance declarations page, a copy of the most recent property tax bill, most recent mortgage statement showing the balance due, property taxes, private mortgage insurance, or homeowner association fee, etc.

In some embodiments, certain audiovisual technology is used in the multi-point, identity, and document verification process. For example, user device 106 used in the multi-point, identity, and document verification may be equipped with the necessary audiovisual accessories (such as a digital camera/webcam). In some embodiments, as described earlier, certain accessory devices and equipment may be pre-installed in the geofence area 102 and may be used in the multi-point, identity verification without necessarily using the user device 106. This then provides a more controlled environment in the remote online processing, thereby enhancing the security of the remote online processing platform disclosed herein.

In some embodiments, the remote online processing platform 108 disclosed herein may allow a user to attend different sessions of remote online processing while the user 104 is in the geofence area 102. For example, for a user seeking a loan or credit approval through eClosing, the user may attend a first remote online session, which can be an online notarization session carried out through an online notarization platform. After the user completes the online notarization session, the user may continue an eClosing session. The user may communicate with an eClosing platform to proceed further with the eClosing. For example, after remote online notarization, certain processes that do not require notarization may be further conducted through the eClosing platform, which may include an instruction for the next action to be taken or to be expected, an instruction for setting up an account, and so on, all of which may be conducted through the eClosing platform.

In some embodiments, the user 104 may leave the geofence area 102 only until the user has completed both remote online notarization and eClosing processes. In some embodiments, the user may only conduct the remote online notarization processes and then walk out of the geofence area without further performing the eClosing processes. To complete eClosing, the user may come back next time to finish the eClosing in the geofence. In the various application scenarios described above, a user may be not allowed to perform processes required in the remote online notarization and eClosing once the user has exited the geofence area, as illustrated in Part (d) of FIG. 1.

In some embodiments, more than one geofence area may be predefined by the geofence-based remote online processing platform disclosed herein. For example, there may be two or more geofences that can be predefined for each city, each county, and each state. A user may be required to perform a remote online processing in a designated geofence or multiple designated geofences, or in any geofence without limitation.

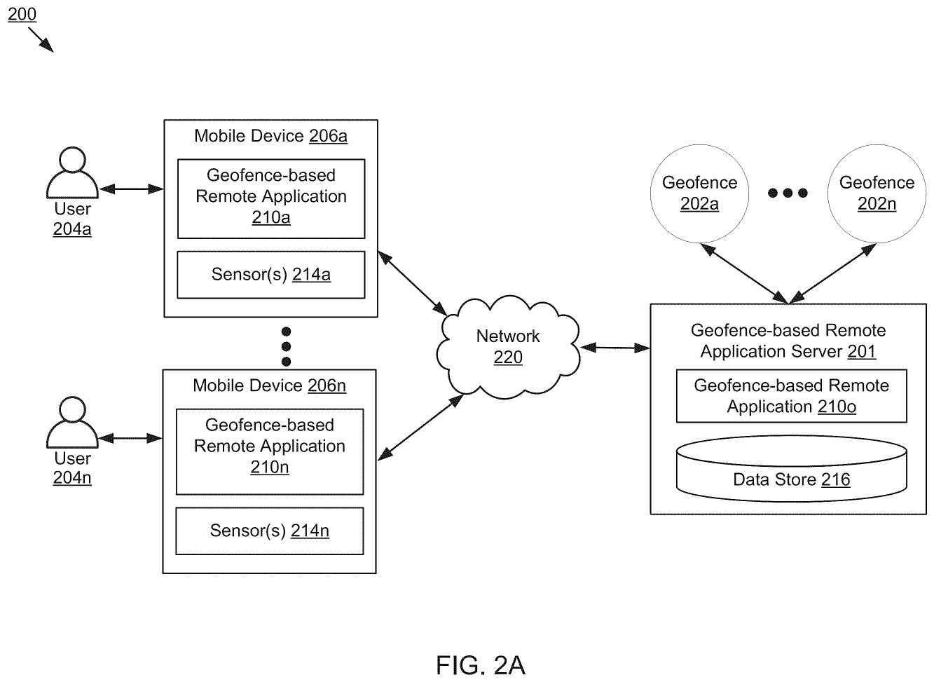

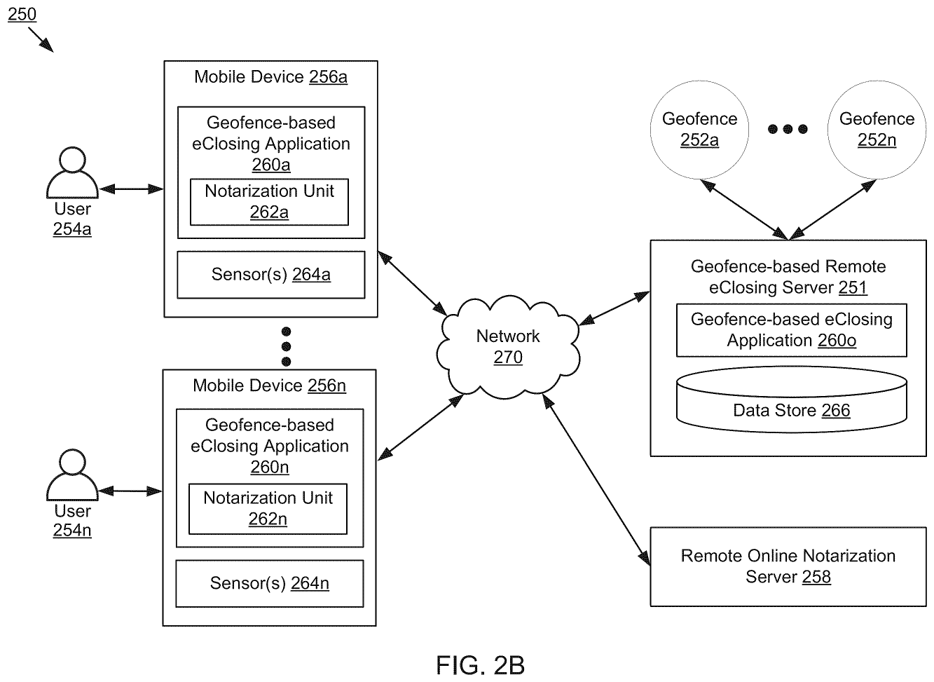

FIG. 2A illustrates an example geofence-based remote online processing (or simply remote processing) system 200, according to one embodiment. As illustrated, the remote processing system 200 includes one or more mobile devices 206a, . . . , 206n (together or individually referred to as “mobile device 206”) coupled to different users 204a, . . . , 204n (together or individually referred to as “user 204”). Also included in the system 200 is a geofence-based remote application server 201. The geofence-based remote application server 201 may further predefine one or more geofence areas 202a, . . . , 202n (together or individually referred to as “geofence or geofence area 202”). As also illustrated in FIG. 2A, one or more network devices 220 may be also included in the system 200 for setting up communications between different components included in the system 200. For example, the user device 206 may communicate with geofence-based remote application server 201 through network 220 for remote processing in a defined geofence area 202.

In some embodiments, the mobile device 206 and geofence-based remote application server 201 may further include a geofence-based remote application 210a/210n/210o (together or individually referred to as “geofence-based remote application 210”), which may implement certain actions necessary for the remote online processing. For example, geofence-based remote application 2100 may include a mapping software configured to allow certain geofence areas to be defined. In some embodiments, the geofence-based remote application 2100 may further include a functional module or unit for determining whether a user has entered a geofence area. Once it is determined that the user has entered the geofence area, the geofence-based remote application server 201 may send a signal (e.g., a message, an email, a calendar invite, an account notification, and the like) to a user device associated with the user or enable certain functions in a user account to allow the user to initiate or participate remote online processing. For example, one or more user interfaces or windows may pop up or be prompted on the user device 206, to enable the user to interact with the geofence-based remote application server 201 and/or another third-party service provider platform (not shown) to perform certain remote online processing.

As illustrated in FIG. 2A, a user device 206 may also include an instance of the geofence-based remote application 210, which may be configured to allow the user device to provide the location information to the geofence-based remote application server 201, and/or interact with the geofence-based remote application server 201. For example, the geofence-based remote application server 201 may be configured to control a digital camera/webcam to turn on or off during a remote online processing session, enable a recording or imaging function to capture certain user inputs, and/or generate a user interface for receiving certain user inputs (e.g., signatures). In some embodiments, additional functions not described above may be implemented by the disclosed geofence-based remote application 210. In some embodiments, the geofence-based remote application server 201 may further collect location information of the user to check whether the user is still within the geofence area when the remote online processing session is still ongoing. In some embodiments, when receiving certain documents or files submitted during the remote online processing, the geofence-based remote application server 201 may also check the metadata associated with the received documents or files to check likely time and location information associated with the files or documents (e.g., when and where the signature was signed, when and where an image was taken, etc.), so as to make sure that the received documents or files are consistent with the expected location information of the geofence area and time information according to the schedule.

In some embodiments, the mobile device 206 may also include one or more sensors 214a, . . . , 214n (together or individually referred to as “sensor 214”. For example, a mobile device 206 may include a GPS sensor or another different positioning sensor that can detect and/or report the location information of the user in real-time. In some embodiments, a mobile device 206 may be configured to consistently send the location information to the geofence-based remote application server 201, to allow the geofence-based remote application server 201 to determine whether the user associated with the mobile device 206 has entered a geofence area 202. In some embodiments, to save the power and communication resources of the mobile device, once the user has entered the geofence area, the mobile device may be controlled to send the location information to server 201 at a lower frequency (e.g., every 30 seconds or at another different frequency). This allows monitoring the remote online processing, to make sure that the processing is still performed within the geofence area.

In some embodiments, the disclosed system 200 may include additional components not described above. For example, one or more data stores may be included in the disclosed system 200. These data stores may be included in the mobile devices 206, geofence-based remote application server 201 (e.g., data store 216), and/or certain cloud-based storage (e.g., Google Cloud, Box, Dropbox, etc.) not shown in FIG. 2A. These data stores may be used to store data generated and/or required during the geofence-based remote online processing. For example, the information related to the geofence area(s), the information and documents, or any other type of data collected before, during, or after the remote online processing may be stored with the permission of the user for instant or later analysis, including possible location and timing verification for possible fault detection. In some embodiments, video and/or audio taken that occurred during the remote online processing are also stored in the cloud and/or in a secure data store designated for such purposes.

Referring now to FIG. 2B, a specific geofence-based remote processing system is further illustrated, according to one embodiment. The system may be a geofence-based remote processing system specifically configured for geofence-based eClosing, and thus is also referred to as the geofence-based remote eClosing system 250. In some embodiments, the geofence-based remote processing system 200 may be also configured for other purposes and thus may have different configurations than those shown in FIG. 2B. It should be noted that the disclosed system for geofence-based remote processing is not limited to the geofence-based remote eClosing system 250, but can be applied to many other different application scenarios that require a certain physical verification, which are not limited in the present disclosure.

As illustrated, the geofence-based remote eClosing system 250 includes one or more mobile devices 256a, . . . , 256n (together or individually referred to as “mobile device 256”) coupled to different users 254a, . . . , 254n (together or individually referred to as “user 254”). Also included in the system 250 are a geofence-based remote eClosing server 251 and a remote online notarization server 258. The geofence-based remote eClosing server 251 may further predefine one or more geofence areas 252a, . . . , 252n (together or individually referred to as “geofence or geofence area 252”). As also illustrated in FIG. 2B, one or more network devices 270 may be also included in the system 250 for setting up communications between different components included in the system 250. For example, the user device 256 may communicate with the geofence-based remote eClosing server 251 and remote online notarization server 258 through network 270 during the geofence-based remote online notarization and eClosing processes.

In some embodiments, the mobile device 256 and geofence-based remote eClosing server 251 may further include a geofence-based eClosing application 260a/260n/260o (together or individually referred to as “geofence-based eClosing application 260”), which may implement certain actions necessary for the geofence-based remote online notarization and eClosing. For example, the geofence-based eClosing application 2600 may include a mapping software configured to allow certain geofence areas to be defined, and a functional module or unit for determining whether a user has entered a geofence area as described in FIG. 2A. Once it is determined that the user has entered the geofence area, the geofence-based remote eClosing server 251 may also send a signal to a user device and/or enable certain actions associated with a user account to initiate a remote online notarization session. For example, one or more user interfaces may be enabled on user device 256, to enable the user to interact with the remote online notarization server 258 to perform certain remote online notarization processes.

As illustrated in FIG. 2B, a user device 256 may also include an instance of geofence-based eClosing application 260, which may be configured to allow the user device to provide the location information to the geofence-based remote eClosing server 251, and also interact with remote online notarization server 258 (associated with a notary) and the geofence-based remote eClosing server 251 (associated with a representative of a loaner). For example, the geofence-based eClosing application 260 on a mobile device 256 may further include a notarization unit 264a/264n (together or individually referred to as “notarization unit 264”) configured to perform certain notarization-related actions on the mobile device. For example, a notarization unit 264 may be configured to control a digital camera/webcam to turn on or off during a remote online notarization session, enable a recording or imaging function to capture certain user inputs, and/or generate a user interface for receiving certain user inputs (e.g., signatures). In some embodiments, additional functions not described above may be implemented by the disclosed geofence-based eClosing application 260 and the associated notarization unit 262 on the mobile device 256.

In some embodiments, the mobile device 256 may also include one or more sensors 264a, . . . , 264n and one or more data stores not shown. The geofence-based remote eClosing server 251 may also include an associated data store 266. A cloud-based data store may be also possible for the disclosed geofence-based remote eClosing system 250. For specific functions of these components, refer to the relevant descriptions in FIG. 2A, details of which will not repeated again here.

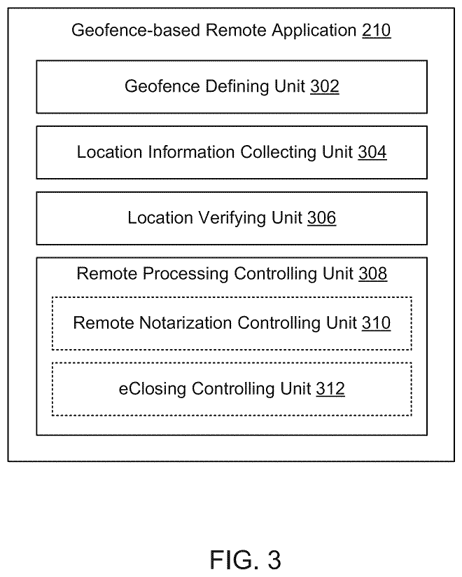

Referring now to FIG. 3, some example components included in a geofence-based remote application 210 (e.g., digital verification application 2010) are further described. According to some embodiments of the disclosure, the geofence-based remote application 210 may include a geofence defining unit 302, a location information collecting unit 304, a location verifying unit 306, and a remote processing control unit 308. In some specific applications, when the geofence-based remote application 210 is a geofence-based eClosing application 260 shown in FIG. 2B, the remote processing controlling unit 308 may optionally include a remote notarization controlling unit 310 and an eClosing controlling unit 312.

The geofence defining unit 302 may be configured to define one or more geofence areas (or simply “geofences”) for a specific area, e.g., within a neighborhood, a city, a county, a state, etc. A geofence area disclosed herein is a location-based tactic that triggers an action when a device associated with a user enters a predetermined location or virtual boundary. The geofence defining unit 302 may use certain mapping software such as a driving application (e.g., Google Map and the like) to define virtual boundaries for the geofence areas disclosed herein. In some embodiments, after a geofence area is defined, certain actions associated with the geofence areas can be further defined. For example, certain texts, emails, alerts, or app notifications may be sent to a mobile device that enters a defined geofence area. In addition, various user activities may be monitored during remote online processing when a user is in a geofence area, depending on the settings in each specific geofence area.

In some embodiments, there may be different types of geofences defined for the disclosed geofence-based remote online processing platform. In one example, there is a first type of geofence configured for remote online notarization processes and a second type of geofence configured for mortgage eClosing processes. In another example, there is a third type of geofence configured for car sale eClosing, a fourth type of geofence configured for HELOC eClosing, a fifth type of geofence configured for bank card applications backed by HELOC, and so on. In some embodiments, different documents are required for each type of application, and thus different verification technologies may be required for each type of geofence-based remote online processing. Accordingly, based on the different types of defined geofences, the geofence defining unit 302 may identify necessary accessories essential for implementing the remote online processing associated with these geofence areas, depending on the purposes of this remote online processing and what activities to be conducted in these geofence areas. It should be noted that, in some embodiments, there is no accessory for a predefined geofence area. Instead, certain functions included in a user device and/or an audiovisual platform may provide necessary functions for remote online processing. In some embodiments, an audiovisual platform may be a specifically configured online meeting platform for remote online processing. In some embodiments, an audiovisual platform may be a third-party online meeting platform such as Zoom Meetings, Microsoft Teams, Google Meet, Go To Meeting, RingCentral, Livestorm, Skype, Zoho Meeting, GoToMeeting, etc. In some embodiments, an audiovisual platform may be a hybrid online platform with certain third-party online meeting platforms integrated into the specifically configured online meeting platform for remote online processing.

The location information collecting unit 304 may be configured to collect the location information of a user through different means. According to some embodiments, the positioning data for the location report can be global positioning data. Global positioning data may include any information collected from positioning systems and apparatus such as the positioning sensors and the like involving locating the user's position relative to satellites, fixed locations, beacons, transmitters, or the like. In some instances, global positioning data may be collected from a GPS device, such as a navigation system mounted in an automobile, on a bike, or taken by the user (e.g., as a wearable device). In some embodiments, positioning data for the location report may include mobile device data. Mobile device data may include information regarding the location of the user's mobile device. Such a mobile device may include but is not limited to, a mobile phone, a tablet, a smartwatch, a personal digital assistant (PDA), a pager, a mobile Internet accessing device, or any other mobile device with positioning functions. For instance, the location of a mobile phone may be dynamically determined by the cell phone signal and cell towers being accessed by the mobile phone. Additionally or alternatively, a mobile device may also locate the location of the device from GPS signals, wireless network locations, and the like. Mobile device data may additionally include data related to the mobile network associated with the mobile device. For instance, the system may determine the location of a mobile device based on the mobile network towers in which the mobile device is used for internet access.

In some embodiments, the mobile device data may be data collected from the surrounding environment, which can be further analyzed for location determination and/or report. For example, a video/image capture sensor/device of a mobile device may capture a video stream or an image of the environment surrounding the mobile device, which allows one to determine the location of the mobile device. For example, when the user is approaching or has entered into the defined geofence area, the video/image captured through the mobile device may be transmitted to the location information collecting unit 304, which can determine whether the user is approaching or has entered into the geofence area based on the video/image. In some embodiments, the metadata information from the video/image may allow to identify the location where the image/video has been taken and when the image/video has been taken. In some embodiments, the image/video may be submitted to a third-party system for determining the location. For example, a photo/image search through Google Image may allow one to identify the object(s) (e.g., building, road sign, business logo, mailbox, etc.), which may assist determination of the location information of the environment where the image/video has been taken.

In some embodiments, the location information collecting unit 304 may also extract the user location information from the video and/or image submitted by a user through other different means. For example, depending on the type and/or configuration of the user device used to take an image, the location information collecting unit 304 may identify the location information by simply checking the image metadata, using a software tool to analyze the image, performing reverse image search, etc.

The location verifying unit 306 may be configured to verify whether and/or when a user has entered into a predefined geofence area based on the collected location information of the user. For example, if the real-time location of the user is collected, the location verifying unit 306 may compare the real-time location information of the user with the boundary of the predefined geofence area, and then determine whether and/or when the user has entered into the predefined geofence area based on the comparison. In some embodiments, a similar method can be also utilized to determine whether and/or when the user has left the predefined geofence area. In some embodiments, if no real-time location information of the user is collected by the location information collecting unit 304, the location verifying unit 306 may request the user to submit additional evidence to confirm that the user is still within a predefined geofence area during an ongoing remote online processing. For example, additional images and/or videos for location/time verification may be submitted by the user during the remote online processing.

In some embodiments, other additional means for verifying that the user has entered into a predefined geofence area are also contemplated in the present disclosure. For example, additional accessories may be set up in a predefined geofence area, which can facilitate confirmation that the user has entered the geofence area. For example, a plate reader can be set up in the entrance(s) of the geofence area, which allows to detect the plate number of the vehicle that the user is driving when entering into the geofence area. In some embodiments, if a digital license plate is used, a same or different plate reader may also identify the digital plate number used for the vehicle. In some embodiments, by using the plate reader, not only the location information of the user but also the identity information related to the user can be used for verifying purposes to prevent possible fault activities. In some embodiments, when the user information is collected prior to an expected remote online processing, vehicle-related information such as the plate number may be also collected from the user. By confirming the plate number of the vehicle the user is driving for remote online processing, this vehicle identity information can provide an additional layer of information for improved security in remote online processing. In some embodiments, a user is advised to drive a vehicle that the user has reported when heading to the predefined geofence area.

In some embodiments, the license plate reader (or another different recognition system) installed at a predefined geofence area may perform an optical character recognition (OCR) on an image taken from the license plate, which can be analyzed to determine a character sequence in the image (i.e., the character sequence on the license plate in the image). In some embodiments, the OCR recognition of the image can be conducted locally by the plate reader itself. In some embodiments, the image can be transmitted to a remote OCR unit or a third party such as Google's OCR engine for plate number recognition. The cognized plate number may be fed back to the plate reader or may be directly sent to the geofence-based remote application server, which then checks whether the recognized plate number is consistent with the user-reported information for the remote online processing. If it matches, the user identity can be considered confirmed, and the remote online processing can be initiated, as will be described later. If it does not match, a notification may be sent to the user that the remote online processing cannot be continued and the user is suggested to drive a car consistent with the report. Alternatively, a user may be prompted to carry out another means of user identity verification remotely. This may include a scanning of a driver license, a credit/debit card or real user ID, another different identification card, or even a biometric scan that can allow to identify the user. Accordingly, in some embodiments, other accessories that can be set up in the geofence area include but are not limited to certain type(s) of card reader, ID reader, biometric reader or scanner (e.g., facial recognition scanner). In some embodiments, a user may “check out” the predefined geofence area based on the similar mechanisms discussed above. In some embodiments, other different means for verifying the user identity are also contemplated. For example, a code is sent to the phone number of the user for verifying purposes.

In some embodiments, not all of this information is required for verification purposes. For example, if the real-time location information clearly shows that the user is inside a geofence area, such information is sufficient to digitally verify the location information of the user. The real-time location information can be GPS location information that accurately determines whether the user is inside or outside a geofence area, and the location information shows that the location is only affiliated with one physical space rather than multiple areas, e.g., multiple-floor buildings. In another example, if a live video stream explicitly shows that a user has entered a geofence area and remains in the geofence area, such a live video stream may be also sufficient for the location verifying unit 306 to digitally verify the user in the geofence area. In some embodiments, to lower the risk and improve fraud defense, more than one of the above-described location verification methods may be used.

Referring back to FIG. 3, the remote processing controlling unit 308 may be configured to facilitate an expected remote online processing, and/or further monitor user activities for the remote online processing. In one example, the remote processing controlling unit 308 may ping a user through different means to make sure the user is still in the predefined geofence area during the remote online processing. For example, a code may be sent to a display installed at the predefined geofence area to confirm that the user is still in the geofence area. In some embodiments, the real-time location information may be still collected from the user, but at a lower frequency to save the sources for communications. Many other different means for collecting user location information (and possible identity information associated with the user) described above may still be used for confirming that the user is still in the predefined geofence area.

In some embodiments, the remote processing controlling unit 308 may further monitor user activities to determine the progress of the remote online processing. For example, if a user is required to submit certain documents, the remote processing controlling unit 308 may check the documents submitted by the user and determine whether all documents are received as expected. In some embodiments, to make sure that the documents are submitted in the predefined geofence area, the accessing point for submitting the documents may be checked to see the location where these documents are submitted (e.g., based on the IP address). In some embodiments, when these documents are signed in the predefined geofence area, not only the actual signature process can be monitored through a camera included in the audiovisual platform used for the processing or through another camera pre-installed at the predefined geofence area, but the time and location when the signature occurred may be also collected through different means. For example, certain digital signature applications may report the time and/or location information of a received digital signature. For a wet signature, a scanned copy may also include information about when and/or where the scanning was performed (e.g., through a user device through a certain scanning application or through a scanner pre-installed in the predefined geofence area). In addition, for a scanned copy, the scanned signature may be further compared to the image taken by a camera during the actual signing process to determine whether the scanned document is the one from the actual signed document. In some embodiments, certain imaging analysis tools or other different means may be included in the geofence-based remote application to facilitate the signature verification.

In some embodiments, the remoting processing controlling unit 308 may include certain functions tuned to specific applications. For example, as shown in FIG. 3, in one example application in geofence-based remote eClosing, the remote processing controlling unit 308 may optionally include certain tools for monitoring remote online notarization and tools for eClosing. For this purpose, a remote notarization controlling unit 310 and an eClosing controlling unit 312 may be optionally included in the remote processing controlling unit 308.

The remote notarization controlling unit 310 may be configured to monitor an online notarization, including using certain secure identity-proofing technologies to view and verify the identity of the signer and notary public prior to starting an online notarization session. For example, the remote notarization controlling unit 310 may control the user in the predefined geofence area to attend the expected online notarization session by sending a link to the user device. When the user clicks the link, the remote notarization controlling unit 310 may pop up a window to allow the user to attend a live video meeting through an approved audiovisual platform. The remote notarization controlling unit 310 may further control the authentication and credential analysis of the user's identity using certain verification tools as described elsewhere herein when the user is asked to verify the user's identity by the notary. After the identity verification, the remote notarization controlling unit 310 may pop up a window on the user device to allow the user to view and sign a document electronically while the notary watches. The remote notarization controlling unit 310 may then pop up a window to the notary that allows the notary to complete the notarial certificate, including adding an electronic seal and/or signature to the document. Once done, the remote notarization controlling unit 310 may control the storage of the signed document in a secure data store and further electronically deliver the electronically signed document to the corresponding entity (ies). Once the user and notary are confirmed to have completed their respective portion and have left the meeting, the remote controlling unit 310 may further control the storage of the whole online notarization session in a secure data store for later verification and/or analysis purposes. In some embodiments, more than one document can be notarized in the online notarization session.

In some embodiments, the remote notarization controlling unit 310 may control a digital seal to be automatically generated when adding the electronic seal to the document. In some embodiments, the automatically generated digital seal also includes tamper evidence, preventing the electronic signature from unauthorized access or tampering. In addition, the audiovisual recording may be also enforced throughout the online notarization session and the user and notary are given notice for recording. Additional security measures monitored by the remote notarization controlling unit 310 include a secure storage and retrieval system used for the online notarization session.

In some embodiments, different methods for location information collection described above can be applied in the online notarization session to ensure that the online notarization is conducted with the predefined geofence area. For example, the IP address for holding the audiovisual stream and for transmitting the documents may be used for location verification, among other possible methods described elsewhere herein.

Referring continuously to FIG. 3, the eClosing controlling unit 312 may be configured to monitor an online eClosing session. In some embodiments, the eClosing controller unit 312 may employ similar techniques used for monitoring online notarization to monitor the eClosing, while the exact documents and attendees for the eClosing may be different. For example, the eClosing controlling unit 312 may control more than two people to attend the eClosing session. The specific details about how the eClosing controlling unit 312 controls the whole eClosing process are not specifically described, details of which may refer to the descriptions regarding the online notarization.

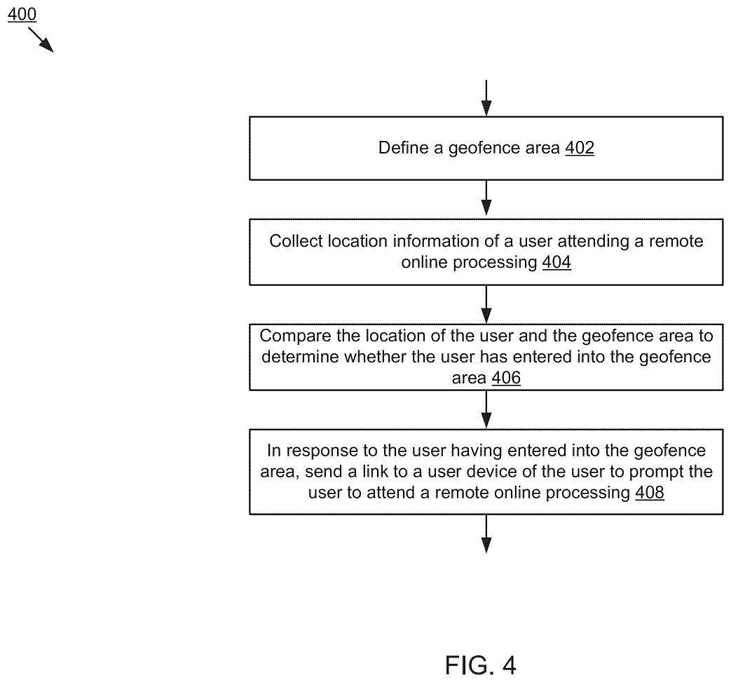

Referring now to FIG. 4, a flow chart of an example method 400 for a geofence-based remote online processing is further provided, according to some embodiments.

At step 402, a geofence area is predefined. In some embodiments, more than geofence areas can be defined. When there are two or more geofence areas defined, these geofence areas can be different or the same and can be for different purposes or for the same purposes. The accessories included in these geofence areas can be also different or the same.

At step 404, location information for a user attending remote online processing is collected. In some embodiments, the user may be instructed through a message and/or a link to report the location information or turn on the location information permission when the user is approaching the predefined geofence area. In some embodiments, the user is given instruction to appear in a predefined geofence area according to a schedule that has been previously agreed upon. The user may be required to report the location information at a certain period ahead of the schedule. For example, if the user is required to enter the predefined geofence area at around 10:30 am according to the schedule, the user may be instructed to turn on the location report function of the user device at around 10:15 am. In some embodiments, a link may be sent to the user device to allow the user to initiate a location report function. The location of the user device may be then tracked to see whether and when the user enters the geofence area. In some embodiments, an instruction may be sent to the user to instruct the user how to turn on the location report function.

At step 406, the location information of the user is compared to the predefined geofence area to determine whether the user has entered into the geofence area. In one example, the location information reported by the user may be compared with the outermost perimeter of the geofence area. If the user has crossed the outermost perimeter of the geofence area based on the collected location information, the user is then determined to have entered the predefined area. In some embodiments, additional means for determining whether the user has entered into the geofence area are also possible and contemplated in the method 400. For example, the image/video taken by the user may also be used to confirm that the user has entered the geofence area. For example, once the user has entered the predefined geofence area, the user may take an image or video that can be further submitted to the disclosed system for confirmation that the user has entered the geofence area. In some embodiments, a specifically designed symbol or another unique sign may be placed in or surrounding the geofence area. When the user takes an image/video, an instruction may be sent to the user, which instructs the user how the image/video should be taken (e.g., pointing to which direction or which object (such as the aforementioned symbol or sign or the like)). In some embodiments, other means for determining whether the user have entered into the predefined geofence area are also possible, as described earlier.

At step 408, in response to the user having entered into the geofence area, a link is sent to a user device of the user to prompt the user to attend a remote online processing. In some embodiments, for security reasons, the link may prompt the user to first log into the user account before the remote online processing starts. In some embodiments, the link may prompt the user to join an audiovisual platform to attend the remote online processing. Accordingly, certain audiovisual accessories (ies) of the user device may be automatically initiated to allow the user to join the remote online processing through the audiovisual platform. In some embodiments, different activities can be conducted when the user attends the remote online processing, details of which are not specifically described. In some embodiments, after the user completes the remote online processing, the user may leave the predefined geofence area. The user is then not allowed to attend the remote online processing. For example, when the user clicks the same link, the link does not open as what happened when the user was in the predefined geofence area. To attend the remote online processing, the user may need to return to the geofence area or need to schedule another remote online processing session.

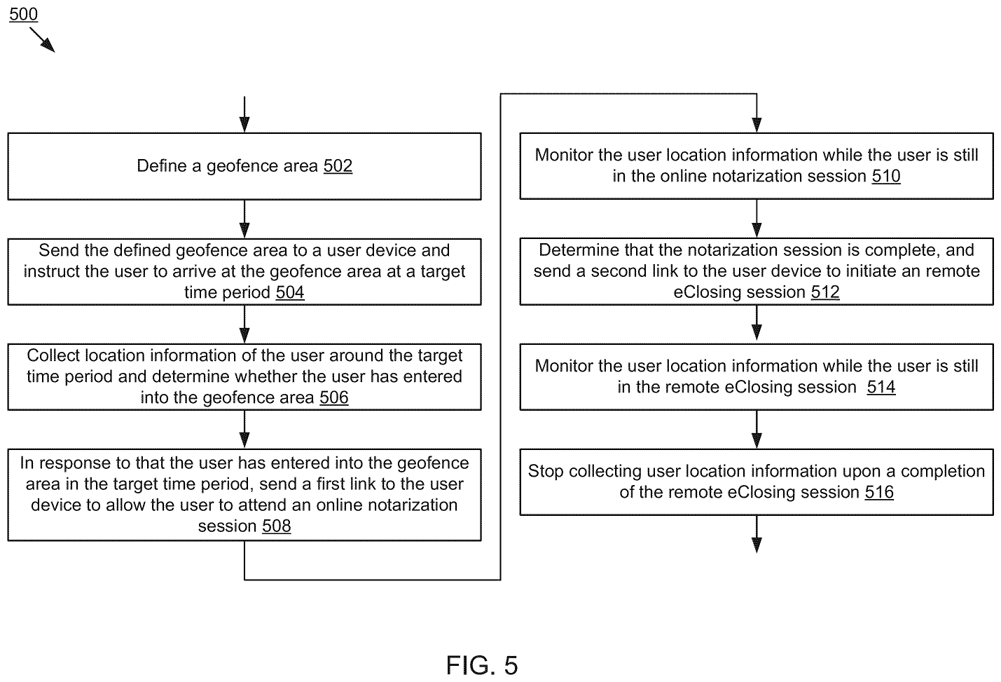

The above method 400 provides a general process performed by the disclosed remote online processing system. In the next, a specific example application of the disclosed system is further described with reference to a remote online eClosing. FIG. 5 illustrates an example method 500 for geofence-based eClosing, according to one embodiment.

At step 502, a geofence area is predefined.

At step 504, the predefined geofence area is sent to a user device of a user, and an instruction is sent to the user to arrive at the predefined geofence area at a target time period.

At step 506, the location information of the user is collected at around the target time period to determine whether the user has entered into the geofence area.

At step 508, in response to the user having entered into the geofence area, a first link is sent to the user device to allow the user to attend an online notarization session.

At step 510, the location information of the user is monitored while the user is still in the online notarization session. In case the user has left the geofence area while the user is still in the online notarization session, a warning may be sent to the user. Under certain circumstances, the ongoing online notarization may be intentionally terminated if the user maintains out of the geofence area.

At step 512, it is determined whether the online notarization session is complete. If it is determined that the online notarization session is completed, a second link is sent to the user device to allow the user to attend a remote eClosing session. It should be noted that, in some embodiments, the same session may allow the online notarization and eClosing to be done sequentially, and a user does not need to attend different remote online sessions to complete the online notarization and the subsequent eClosing.

At step 514, the location of the user is also monitored while the user is still in the remote eClosing session. If it is found that the user has left the geofence area while still in the ongoing session, a warning may be issued, and/or the ongoing remote eClosing session may be intentionally terminated.

At step 516, the location information of the user is not collected upon the completion of the remote eClosing session. In some embodiments, the location information of the user is still collected until the user is found to have left the geofence area.

It should be noted that in the various embodiments described above, the link for attending remote online processing sent to a user is not limited to a situation until after the user has entered a predefined geofence area. In some embodiments, a link can be sent to the user at any time before the user enters a predefined geofence area. For example, a link may be sent to a user through a calendar invite, an appointment confirmation or reminder, or through many other means. However, the link may become active (e.g., the user is able to attend the expected remote online processing) only until the user has entered the defined geofence area.

In some embodiments, machine learning models may be used in one or more of the above-described methods for remote online processing. For example, a machine learning model may be trained to compare signatures collected under different situations for the same user if a wet signature is used. The trained machine learning model may be then able to determine whether the signatures collected through the remote online processing and the signatures collected through the other resources (e.g., driver licenses) are from the same user. In some embodiments, another machine learning model may be trained to identify whether the collected image documents include certain fake documents or not. For example, a machine learning model may be trained to determine whether a driver license shown in an image is a real or fake one. In some embodiments, other different machine learning models may be used to verify the collected documents or for other different purposes, which is not limited in the present disclosure. In some embodiments, the various machine learning-based methods or non-machine learning-based methods for verification may be performed while the user is still in a predefined geofence area.

In some embodiments, additional verification processes may be performed after the user has left a predefined geofence area. In some embodiments, all of these remote online notarization processes and the interactions with the representative(s) of the loaner may be logged and saved in the data store for further review and auditing, if necessary.

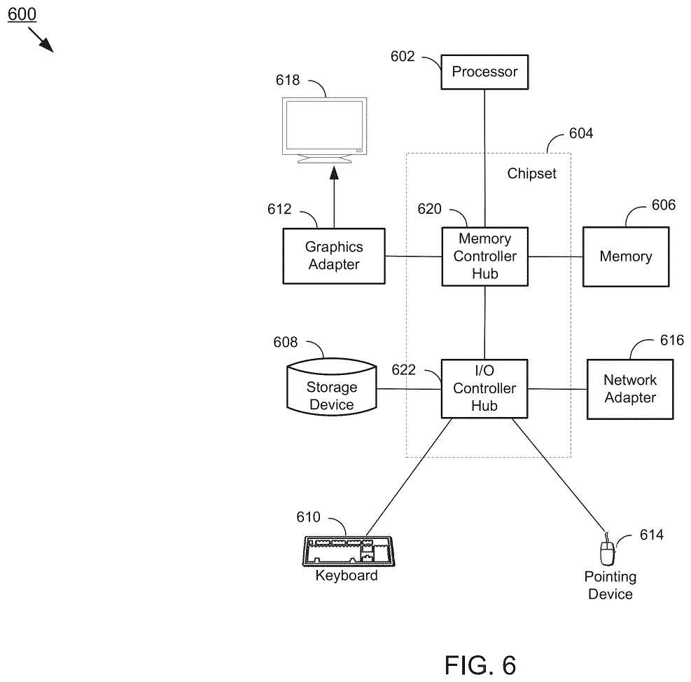

FIG. 6 depicts an example computing device 600 for implementing systems and methods described in reference to FIGS. 1-5. Examples of a computing device may include a personal computer, desktop computer, laptop, server computer, a computing node within a cluster, message processors, hand-held devices, multi-processor systems, microprocessor-based or programmable consumer electronics, network PCs, minicomputers, mainframe computers, mobile telephones, PDAs, tablets, pagers, routers, switches, edge devices, IoT devices, and the like.

In some embodiments, the computing device 600 includes at least one processor 602 coupled to a chipset 604. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, an input interface 614, and a network adapter 616 are coupled to the I/O controller hub 622. Other embodiments of the computing device 600 have different architectures.

The storage device 608 is a non-transitory computer-readable storage medium such as a hard drive, compact disk read-only memory (CD-ROM), DVD, or a solid-state memory device. The memory 606 holds instructions and data used by the processor 602. The input interface 614 is a touch-screen interface, a mouse, trackball, or other types of input interface, a keyboard 610, or some combination thereof, and is used to input data into the computing device 600. In some embodiments, the computing device 600 may be configured to receive input (e.g., commands) from the input interface 614 via gestures from the user. The graphics adapter 612 displays images and other information on the display 618. The network adapter 616 couples the computing device 600 to one or more computer networks.

The computing device 600 is adapted to execute computer program modules for providing the functionality described herein. As used herein, the term “module” refers to computer program logic used to provide the specified functionality. Thus, a module may be implemented in hardware, firmware, and/or software. In one embodiment, program modules are stored on the storage device 608, loaded into the memory 606, and executed by the processor 602.

The types of computing devices 600 may vary from the embodiments described herein. For example, the computing device 600 may lack some of the components described above, such as graphics adapters 612, input interface 614, and displays 618. In some embodiments, a computing device 600 may include a processor 602 for executing instructions stored on a memory 606.

The methods disclosed herein may be implemented in hardware or software, or a combination of both. In one embodiment, a non-transitory machine-readable storage medium, such as the one described above, is provided, the medium comprising a data storage material encoded with machine-readable data which, when using a machine programmed with instructions for using said data, is capable of displaying any of the datasets and execution and results of this disclosure. Such data may be used for a variety of purposes, such as patient monitoring, treatment considerations, and the like. Embodiments of the methods described above may be implemented in computer programs executing on programmable computers, comprising a processor, a data storage system (including volatile and non-volatile memory and/or storage elements), a graphics adapter, an input interface, a network adapter, at least one input device, and at least one output device. A display is coupled to the graphics adapter. Program code is applied to input data to perform the functions described above and generate output information. The output information is applied to one or more output devices, in a known fashion. The computer may be, for example, a personal computer, microcomputer, or workstation of conventional design.

Each program may be implemented in a high-level procedural or object-oriented programming language to communicate with a computer system. However, the programs may be implemented in assembly or machine language, if desired. In any case, the language may be a compiled or interpreted language. Each such computer program is preferably stored on a storage media or device (e.g., ROM or magnetic diskette) readable by a general or special-purpose programmable computer, for configuring and operating the computer when the storage media or device is read by the computer to perform the procedures described herein. The system may also be considered to be implemented as a computer-readable storage medium, configured with a computer program, where the storage medium so configured causes a computer to operate in a specific and predefined manner to perform the functions described herein.

The databases thereof may be provided in a variety of media to facilitate their use. The databases of the present disclosure may be recorded on computer-readable media, e.g., any medium that may be read and accessed directly by a computer. Such media include, but are not limited to: magnetic storage media, such as floppy discs, hard disc storage medium, and magnetic tape; optical storage media such as CD-ROM; electrical storage media such as RAM and ROM; and hybrids of these categories such as magnetic/optical storage media. One of skill in the art may readily appreciate how any of the presently known computer readable mediums may be used to create a manufacture comprising a recording of the present database information. “Recorded” refers to a process for storing information on a computer-readable medium, using any such methods as known in the art. Any convenient data storage structure may be chosen, based on the means used to access the stored information. A variety of data processor programs and formats may be used for storage, e.g., word-processing text files, database format, etc.

While this disclosure may contain many specifics, these should not be construed as limitations on the scope of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

What is claimed is:

1. A system for geofence-based remote online processing, comprising:
a processor; and
a memory, coupled to the processor, configured to store executable instructions that, when executed by the processor, cause the processor to perform operations comprising:
defining a geofence area for a geofence-based remote online processing;
collecting location information of a user attending to the geofence-based remote online processing;
comparing the location information of the user with the geofence area to determine whether the user has entered into the geofence area; and
in response to the user having entered into the geofence area, activating a link sent to a user device of the user to allow the user to attend the remote online processing through an audiovisual platform.

2. The system of claim 1, wherein the location information is determined through communications between the user device associated with the user and a base station using techniques including trilateration or triangulation.

3. The system of claim 1, wherein the remote online processing includes one or more of an online notarization session or a remote eClosing session.

4. The system of claim 1, wherein the online notarization session includes conducting a digital seal of a document.

5. The system of claim 4, wherein the digital seal is automatically generated in the online notarization session.

6. The system of claim 4, wherein the digital seal includes tamper evidence for preventing an electronic signature from unauthorized access or tampering.

7. The system of claim 1, wherein collecting the location information of the user includes consistently collecting the location information of the user while the user is still in the remote online processing.

8. The system of claim 7, wherein the location information of the user is collected at a lower frequency when the user is still in the remote online processing when compared to the user not in the remote online processing session.

9. The system of claim 1, wherein the online remote online processing is terminated on the user device through the audiovisual platform when the user is determined to have left the geofence area while the user is still attending the remote online processing.

10. The system of claim 1, wherein the remote online processing is recorded and saved at a predefined location upon completion of the remote online processing.

11. The system of claim 1, wherein the geofence area is equipped with one or more accessories for determining the location information of the user.

12. The system of claim 11, wherein the one or more accessories include a plate reader for reading a plate number of a vehicle associated with the user.

13. The system of claim 1, wherein the geofence area is equipped with one or more accessories for verifying a user identity of the user.

14. The system of claim 13, wherein the one or more accessories include one or more of a credit/debit card reader, an ID reader, or a biometric reader or scanner.

15. A computer-implemented method, comprising:
defining a geofence area for a geofence-based remote online processing;
collecting location information of a user attending to the geofence-based remote online processing;
comparing the location information of the user with the geofence area to determine whether the user has entered into the geofence area; and
in response to the user having entered into the geofence area, activating a link sent to a user device of the user to allow the user to attend the remote online processing through an audiovisual platform.

16. The computer-implemented method of claim 15, wherein the location information is determined through communications between the user device associated with the user and a base station using techniques including trilateration or triangulation.

17. The computer-implemented method of claim 15, wherein collecting the location information of the user includes consistently collecting the location information of the user while the user is still in the remote online processing.

18. The computer-implemented method of claim 17, wherein the location information of the user is collected at a lower frequency when the user is still in the remote online processing when compared to the user not in the remote online processing session.

19. The computer-implemented method of claim 15, wherein the online remote online processing is terminated on the user device through the audiovisual platform when the user is determined to have left the geofence area while the user is still attending the remote online processing.

20. The computer-implemented method of claim 15, wherein the remote online processing is recorded and saved at a predefined location upon a completion of the remote online processing.
